(19) United States
(12) Patent Application Publication
(10) Pub. No.: US 2026/0296399 A1
(43) Pub. Date: Oct. 1, 2026

(54) MODE TRANSITION SHIFT MANAGEMENT

(71) Applicant: JAGUAR LAND ROVER LIMITED, Warwickshire (GB)

(72) Inventors: Romain LACROISILLE, Whitley, Coventry, Warwickshire (GB); Tom OWEN, Whitley, Coventry, Warwickshire (GB); James CANNON, Whitley, Coventry, Warwickshire (GB); Robert CREAN, Whitley, Coventry, Warwickshire (GB)

(21) Appl. No.: 19/480,907

(22) PCT Filed: May 2, 2024
(86) PCT No.: PCT/EP2024/062027

§ 371 Date: Nov. 3, 2025

(30) Foreign Application Priority Data
May 2, 2023 (GB) 2306440.5

(51) Int. Cl. B60W 20/30; B60W 20/15

(52) U.S. Cl. CPC B60W 20/30; B60W 20/15; B60W 2510/081; B60W 2520/30; B60W 2540/10; B60W 2710/1005

(57) ABSTRACT

Aspects and embodiments of the invention relate to a control system (100), an automatic transmission system (10), a vehicle (1), a method (400), and computer readable instructions, for controlling an automatic transmission (12) of a vehicle (1), comprising: receiving (410) an input signal indicative of a status of a propulsion system (22) of the vehicle (1); obtaining (430) a current wheel torque in dependence on the propulsion system (22) being in transition from an electric mode to a parallel hybrid mode; determining (440) an available wheel torque in one or more gear ratios which are selectable within the automatic transmission (12); determining (450) whether the available wheel torque in the one or more gear ratios exceeds a predefined fraction of the obtained wheel torque; permitting (460) shifting to any of the one or more gear ratios in which the available wheel torque exceeds the predefined fraction of the obtained wheel torque; and inhibiting (470) shifting to any of the one or more gear ratios in which the available wheel torque is less than or equal to the predefined fraction of the obtained wheel torque.

### TECHNICAL FIELD

The present disclosure relates to mode transition shift management. Aspects of the invention relate to a control system, to an automatic transmission system, to a vehicle, to a method, and to computer readable instructions.

### BACKGROUND

It is known to provide automatic transmissions in vehicles. Automatic transmissions do not require input from a driver to shift gears.

Gear management is instead provided to determine when it is appropriate to shift gear and what gear is appropriate to adopt in a given set of circumstances.

For vehicles which have multiple modes of propulsion (e.g., electric mode or parallel hybrid mode), gear management during mode transition can be challenging because, for example, a gear which is appropriate for one mode of propulsion may not be appropriate in another.

### SUMMARY OF THE INVENTION

Aspects and embodiments of the invention provide a control system, an automatic transmission system, a vehicle, a method, and computer readable instructions as claimed in the appended claims.

According to an aspect of the present invention there is provided a control system for an automatic transmission of a vehicle comprising any one or more of the features described herein.

According to an aspect of the present invention there is provided a control system for an automatic transmission of a vehicle. The control system comprises one or more controllers. The control system configured to:
receive an input signal indicative of a status of a propulsion system of the vehicle;
obtain a current wheel torque in dependence on the propulsion system being in transition from an electric mode to a parallel hybrid mode;
determine an available wheel torque in one or more gear ratios which are selectable within the automatic transmission;
determine whether the available wheel torque in the one or more gear ratios exceeds a predefined fraction of the obtained wheel torque;
permit shifting to any of the one or more gear ratios in which the available wheel torque exceeds the predefined fraction of the obtained wheel torque; and
inhibit shifting to any of the one or more gear ratios in which the available wheel torque is less than or equal to the predefined fraction of the obtained wheel torque.

Reference to ‘the control system being configured to’ is to be understood to mean ‘the one or more controllers of the control system are collectively configured to’.

An advantage of determining whether to permit or inhibit gear shifts based on available wheel torque in a resultant gear ratio is that a drop in wheel torque that may be experienced can be managed to acceptable levels or avoided.

Optionally the control system is configured to: receive a signal indicative of a current torque at an input shaft to the automatic transmission; and determine the available wheel torque in the one or more gear ratios by multiplying respective ones of the one or more gear ratios by a final drive ratio and by either: the current torque at the input shaft to the automatic transmission or a projected torque at the input shaft to the automatic transmission.

Optionally the control system is configured to: receive a signal indicative of a power limit applied to an electric machine; and receive a signal indicative of a current speed of the electric machine. Optionally the projected torque at the input shaft to the automatic transmission is given by a minimum between: (i) the power limit applied to the electric machine, multiplied by a gear ratio between the electric machine and the input shaft, divided by an expected speed of the electric machine at a current vehicle speed for respective ones of the one or more gear ratios; and (ii) a target torque for the input shaft based on an accelerator input.

Optionally the expected speed of the electric machine at the current vehicle speed for respective ones of the one or more gear ratios is given by: the current speed of the electric machine, multiplied by respective ones of the one or more gear ratios, divided by a current gear ratio.

Optionally the control system is configured to: determine if the current torque at the input shaft to the automatic transmission is within a tuneable offset of: the power limit applied to the electric machine, multiplied by a gear ratio between the electric machine and the input shaft to the automatic transmission, divided by the current speed of the electric machine. If so, the available wheel torque in the one or more gear ratios may be determined by multiplying respective ones of the one or more gear ratios by the projected torque at the input shaft to the automatic transmission and by the final drive ratio. If not, the available wheel torque in the one or more gear ratios may be determined by multiplying respective ones of the one or more gear ratios by the current torque at the input shaft to the automatic transmission and by the final drive ratio.

Optionally the control system is configured to: continue determining an available wheel torque in one or more gear ratios and continue inhibiting shifting to any of the one or more gear ratios in which the available wheel torque does not exceed the predefined fraction of the obtained wheel torque while the propulsion system is in transition from the electric mode to the parallel hybrid mode and for a predefined period following completion of the transition into the parallel hybrid mode.

Optionally the control system is configured to: determine whether the available wheel torque in the one or more gear ratios exceeds at least one from the following: a predefined fraction of a wheel torque demand; a predefined fraction of an available wheel torque in a current gear ratio.

Optionally permitted shifting is limited to those of the one or more gear ratios in which the available wheel torque exceeds at least one from the following: the predefined fraction of the wheel torque demand; the predefined fraction of the available wheel torque in a current gear ratio.

An advantage of limiting permitted shifting to gear ratios in which the available wheel torque exceeds a predefined fraction of the wheel torque demand is that inappropriate gear shifts can be avoided. If the wheel torque demand cannot be met to an acceptable level in a particular gear ratio, that gear ratio may not be appropriate.

An advantage of limiting permitted shifting to gear ratios in which the available wheel torque exceeds a predefined fraction of the available wheel torque in a current gear ratio is that unnecessary gear shifts may be avoided. If the available wheel torque in a particular gear ratio is not sufficiently more than could be achieved in the current gear ratio, shifting to that gear ratio may not be necessary.

Optionally the wheel torque demand is given by: a target torque for an input shaft to the automatic transmission based on an accelerator input, multiplied by the current gear ratio, multiplied by a final drive ratio.

Optionally the available wheel torque in the current gear ratio is given by: a gear ratio between the electric machine and the input shaft to the automatic transmission, multiplied by the current gear ratio, multiplied by a final drive ratio, multiplied by a minimum between: (i) a maximum available electric machine torque indicated by a received input signal; (ii) a power limit applied to the electric machine, divided by the current speed of the electric machine.

Optionally the control system is configured to: determine if the wheel torque demand is increasing by at least a threshold amount or at at least a threshold rate. If the wheel torque demand is increasing by at least the threshold amount or at at least the threshold rate, permitted shifting may be limited those of the one or more gear ratios in which the available wheel torque exceeds both the predefined fraction of the wheel torque demand and the predefined fraction of the available wheel torque in the current gear ratio.

Optionally, if the wheel torque demand is not increasing by at least the threshold amount or at at least the threshold rate, permitted shifting is limited those of the one or more gear ratios in which the available wheel torque exceeds a predefined fraction of a minimum between: (i) the wheel torque demand; and (ii) the available wheel torque in the current gear ratio.

Optionally the control system is configured to receive an input signal indicative of the current wheel torque.

Optionally the control system is configured to: receive an input signal indicative of a current torque produced by an electric machine; and determine the current wheel torque. The current wheel torque may be determined by: the current torque produced by the electric machine, multiplied by a gear ratio between the electric machine and the input shaft to the automatic transmission, multiplied by the current gear ratio, multiplied by a final drive ratio.

Optionally the control system is configured to:
receive a signal indicative of a speed parameter;
receive a signal indicative of accelerator input;
determine a target gear ratio based on the speed parameter and the accelerator input;
output a signal comprising instructions to cause initiation of a shift to the target gear ratio in dependence on the target gear ratio being any of the one or more gear ratios in which the available wheel torque exceeds the predefined fraction of the obtained wheel torque; and
inhibit output of a signal comprising instructions to cause initiation of a shift to the target gear ratio for at least a predefined period of time in dependence on the target gear ratio being any of the one or more gear ratios in which the available wheel torque does not exceed the predefined fraction of the obtained wheel torque.

According to a further aspect of the invention, there is provided an automatic transmission system comprising the control system.

According to a further aspect of the invention, there is provided a vehicle comprising the automatic transmission system.

According to a further aspect of the invention, there is provided a method of controlling an automatic transmission of a vehicle, the method comprising:
receiving an input signal indicative of a status of a propulsion system of the vehicle;
obtaining a current wheel torque in dependence on the propulsion system being in transition from an electric mode to a parallel hybrid mode;
determining an available wheel torque in one or more gear ratios which are selectable within the automatic transmission;
determining whether the available wheel torque in the one or more gear ratios exceeds a predefined fraction of the obtained wheel torque;
permitting shifting to any of the one or more gear ratios in which the available wheel torque exceeds the predefined fraction of the obtained wheel torque; and
inhibiting shifting to any of the one or more gear ratios in which the available wheel torque is less than or equal to the predefined fraction of the obtained wheel torque.

According to a further aspect of the invention there is provided computer readable instructions which, when executed by a computer, are arranged to perform any one or more of the methods described herein. According to a further aspect of the invention there is provided a non-transitory computer readable medium comprising computer readable instructions that, when executed by one or more electronic processors, causes the one or more electronic processors to carry out any one or more of the methods described herein.

Within the scope of this application, it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIG. 2 illustrates an example of at least part of a powertrain of a vehicle;

FIG. 3 illustrates an example of a control system;

FIG. 4 illustrates an example of a non-transitory computer-readable storage medium;

FIGS. 5A to B illustrate graphs providing context to the disclosure;

FIGS. 6A to B illustrate graphs providing context to the disclosure;

FIG. 7 illustrates an example of a method;

FIG. 8 illustrates a further example of the method;

FIG. 9 illustrates a further example of the method;

FIG. 10 illustrate a further example of the method

FIG. 11 illustrates a further example of the method;

FIG. 12 illustrates a further example of the method; and

FIG. 13 illustrates a further example of the method.

### DETAILED DESCRIPTION

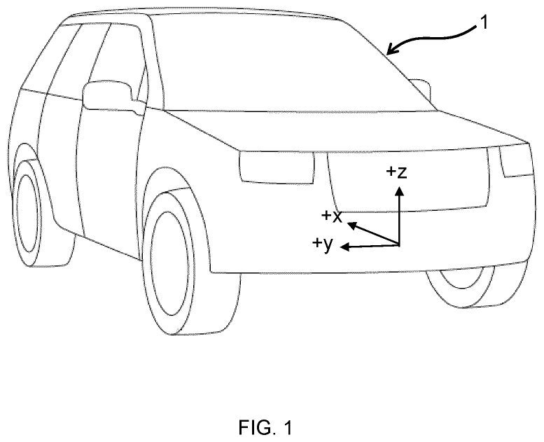

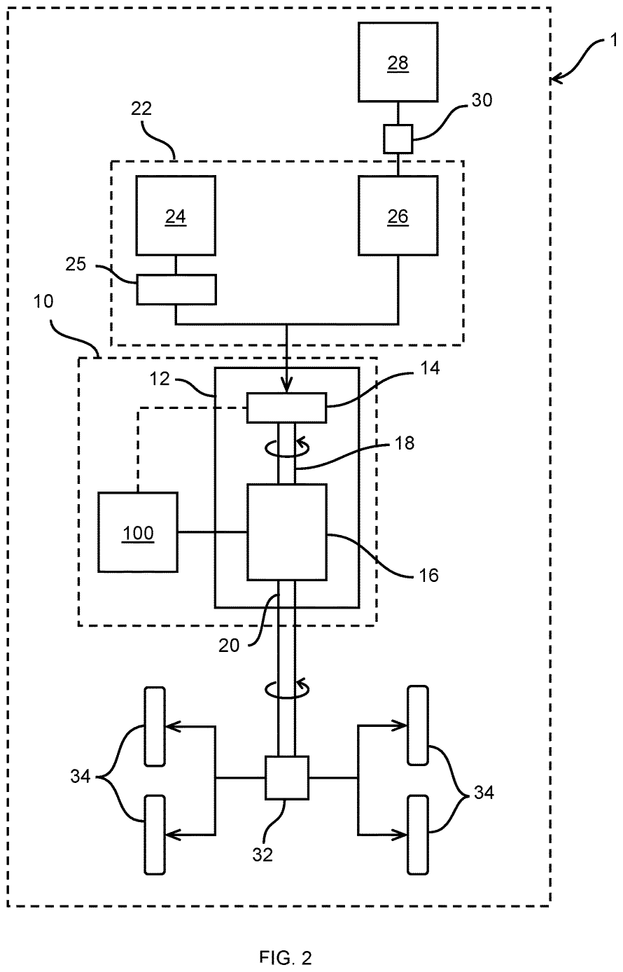

A vehicle 1 in accordance with an embodiment of the present invention is described herein with reference to the accompanying FIG. 1. In some, but not necessarily all examples, the vehicle 1 is a passenger vehicle, also referred to as a passenger car or as an automobile. In other examples, embodiments of the invention can be implemented for other applications, such as commercial vehicles. FIG. 2 schematically illustrates an example of at least part of a powertrain of the vehicle 1.

In this example, the vehicle 1 comprises a propulsion system 22 comprising a plurality of torque sources 24, 26 which are selectively operable for the purpose of providing drive torque for accelerating the vehicle 1.

A torque source refers to a prime mover, such as an internal combustion engine, an electric machine such as a traction motor, or the like. In the illustrated example, the propulsion system 22 comprises two torque sources 24, 26. A first torque source 24 is an internal combustion engine (‘engine’). A second torque source 26 is an electric machine.

The electric machine 26 is an electric motor arranged to convert electrical energy into kinetic energy in the form of mechanical torque and vice versa. The electric motor 26 may be an alternating current induction motor or a permanent magnet motor, or another type of motor. The electric machine 26 is a traction motor configured to enable at least an electric mode comprising electric-only driving. That is, the electric machine 26 can drive the vehicle by itself (without an engine). This propulsion system 22 is configured to operate in a plurality of predefined operating modes. These include at least an electric mode and a parallel hybrid mode.

In the electric mode (also known as electric vehicle (EV) mode or electric-only mode) the vehicle 1 is propelled only by torque generated by the electric machine 26. The engine 24 may be off (in a non-running state) such that fuel is not combusted, though it may still be rotating if not disconnected from the wheels 34. The engine 24 may alternatively be on but only for the purpose of generating electrical energy and not connected to a torque path to the wheels 34. In the parallel hybrid mode the vehicle 1 is propelled by torque generated by both the engine 24 and by the electric machine 26. The predefined operating modes may also include an engine-only mode in which the vehicle 1 is propelled only by torque generated by the engine 24 and there is no electric propulsion.

Transitioning between predefined operating modes of the propulsion system 22 comprises turning on or off one of the torque sources 24, 26 so that, respectively, it either does or does not output torque. In some examples, transitioning between predefined operating modes further comprises mechanically connecting (coupling) or disconnecting (uncoupling) one of the torque sources 24, 26 to the drivetrain. A coupling clutch 25 is provided to mechanically connect and disconnect the engine 24 from the drivetrain. It will be appreciated that the transition between the predefined operating modes is not instantaneous. While the propulsion system 22 is transitioning between predefined operating modes, its mode status is ‘in transition’.

The vehicle 1 comprises an automatic transmission system 10 comprising an automatic transmission 12 and a control system 100 such as a transmission control unit/module for controlling the automatic transmission 12. The automatic transmission 12 comprises a launch device 14 which transfers torque output by the operating torque sources 24, 26 of the propulsion system 22 to the transmission input shaft 18. The launch device 14 may be a fluid coupling such as a torque converter or one or more automatically-actuated friction clutches as found in, for example, a dual-clutch transmission.

The automatic transmission 12 also comprises a gear set and accompanying shifting mechanism, referenced in combination as 16. The gear set 16 comprises a plurality of gears which are selectively couplable into different gear trains to enable multiple gear ratios between the transmission input shaft 18 and the transmission output shaft 20. Each gear may have a corresponding clutch configured to couple them (directly or indirectly) to the transmission output shaft 20.

The clutches and their actuators form the shifting mechanism. The actuators may be solenoids. The shifting mechanism is controlled to establish a selected gear ratio in accordance with a control signal output by the control system 100. The control system 100 may determine which clutches are involved in shifting to the selected gear ratio and determine how the pressure at the clutches should be controlled to establish the selected gear ratio. The control system 100 may then directly control the actuators associated with these clutches to increase or decrease pressure at these clutches as required. The control system 100 is also capable of controlling actuation of the launch device 14. The transmission output shaft 20 is connected to a final set of gears 32, such as a pinion gear meshed with a ring gear, to transfer torque to the wheel axles and thus the vehicle wheels 34.

In order to store electrical energy for the electric machine 26, the vehicle 1 comprises an electrical energy storage means 28. The electrical energy storage means 28 can be a traction battery. The traction battery 28 provides a nominal voltage required by electrical power users such as the electric machine 26. The traction battery 28 may be a high voltage battery. The traction battery 28 may have a voltage and capacity to support electric only driving for sustained distances. The traction battery 28 may have a capacity of several kilowatt-hours, to maximise range. The capacity may be in the tens of kilowatt-hours, or even over a hundred kilowatt-hours.

Although the traction battery 28 is illustrated as one entity, the function of the traction battery 28 could be implemented using a plurality of small traction batteries in different locations on the vehicle 1. An inverter 30 converts between the DC output of the traction battery 28 and the AC input required for the electric machine 26.

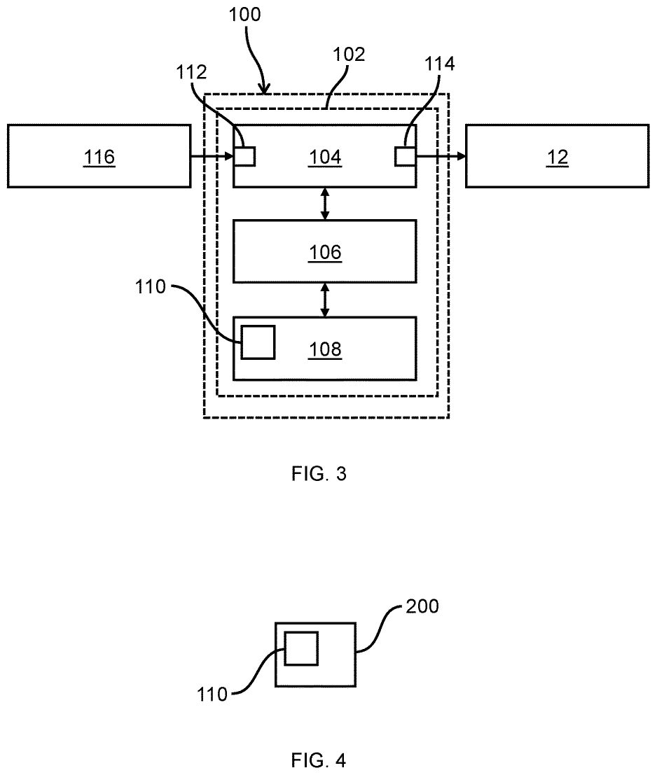

In view of the above description of the vehicle 1, it will be understood that the vehicle 1 is a full hybrid electric vehicle (HEV). However, in some examples the vehicle 1 may be other than as shown in FIG. 2. FIG. 3 illustrates an example of the control system 100 for the automatic transmission 12 of the vehicle 1. The control system 100 comprises one or more controllers 102.

The control system 100 is configured to receive data from multiple sensors 116 or other control systems. The control system 100 is configured to receive data about the status of the propulsion system 22 and data about a current wheel torque or from which the current wheel torque can be determined. The data about the status of the propulsion system 22 can comprise the status of the propulsion system 22 or can, for example, comprise the status of the coupling clutch 25 to ascertain if the engine 24 is mechanically connected to the transmission 12 or not in view of which the status of the propulsion system 22 can be determined. The current wheel torque can be determined based on estimated engine torque and the estimated electric machine torque. The electric machine torque can be estimated from the current and voltage provided to the electric machine 26. The engine torque can be estimated based on a combustion model incorporating airflow, fueling, spark and other inputs.

The control system 100 is configured to determine permitted gear ratios during an electric to parallel hybrid mode transition by assessing the potential drop in wheel torque in one or more gear ratios. The control system 100 may then permit shifting to those gear ratios while inhibiting shifting to others, for example by outputting a control signal comprising instructions to cause initiation of a shift (by for example controlling the automatic transmission 12, and specifically the shifting mechanism which functions to establish a gear ratio) in respect of only those permitted gear ratios.

The control system may also be configured to receive accelerator input data from, for example, an accelerator pedal sensor or a system processing the output of the accelerator pedal sensor to determine a torque to request of the propulsion system 22 or from an automated driving system (ADS) or an advanced driver-assistance system (ADAS). The control system may also be configured to receive speed parameter data from, for example, a crank position sensor, a drivetrain speed sensor, a wheel speed sensor measure, or the like. The control system 100 may be configured to determine a target gear ratio based on the accelerator input data and the speed parameter data. The control system 100 may then output a control signal comprising instructions to cause initiation of a shift to the target gear ratio if it is one of the permitted gear ratios.

The control system 100 as illustrated in FIG. 3 comprises one controller 102, although it will be appreciated that this is merely illustrative. The controller 102 comprises processing means 106 and memory means 108. The processing means 106 may be one or more electronic processing devices 106 which operably execute computer-readable instructions. The memory means 108 may be one or more memory devices 108. The memory means 108 is electrically coupled to the processing means 106. The memory means 108 is configured to store instructions, and the processing means 106 is configured to access the memory means 108 and execute the instructions stored thereon.

The controller 102 comprises an input means 112 and an output means 114. The input means 112 may comprise an electrical input 112 of the controller 102. The output means 114 may comprise an electrical output 114 of the controller 102. The controller 102 may have an interface 104 comprising an electrical input/output I/O 112, 114, or an electrical input 112, or an electrical output 114, for receiving information and interacting with external components. The input 112 is arranged to receive a plurality of signal from a plurality of sensors 116 or other control systems. At least one signal is an electrical signal which is indicative of a status of the propulsion system 22. At least one other signal is an electrical signal which is indicative of current wheel torque or from which the current wheel torque can be determined. Other received signals may include an electrical signal which is indicative of an accelerator input and an electrical signal which is indicative of a speed parameter. The output 114 is arranged to output control signals comprising instructions to cause initiation of a gear shift.

FIG. 4 illustrates a non-transitory computer-readable storage medium 200 comprising the instructions (computer software). It is to be understood that the or each controller 102 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 102 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 102 to implement the control techniques described herein (including some or all of the functionality required for the method(s) described herein). The set of instructions 110 could be embedded in said one or more electronic processors 106 of the controller 102; or alternatively, the set of instructions 110 could be provided as software to be executed in the controller 102. A first controller or control unit may be implemented in software run on one or more processors. One or more other controllers or control units may be implemented in software run on one or more processors, optionally the same one or more processors as the first controller or control unit. Other arrangements are also useful.

The, or each, electronic processor 106 may comprise any suitable electronic processor (e.g., a microprocessor, a microcontroller, an ASIC, etc.) that is configured to execute electronic instructions 110. The, or each, electronic memory device 108 may comprise any suitable memory device and may store a variety of data, information, threshold value(s), lookup tables or other data structures, and/or instructions therein or thereon. In an embodiment, the memory device 108 has information and instructions for software, firmware, programs, algorithms, scripts, applications, etc. stored therein or thereon that may govern all or part of the methodology described herein. The processor, or each, electronic processor 106 may access the memory device 108 and execute and/or use that or those instructions and information to carry out or perform some or all of the functionality and methodology described herein.

The at least one memory device 108 may comprise a computer-readable storage medium (e.g. a non-transitory or non-transient storage medium) that may comprise any mechanism for storing information in a form readable by a machine or electronic processors/computational devices. Examples of the form include, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

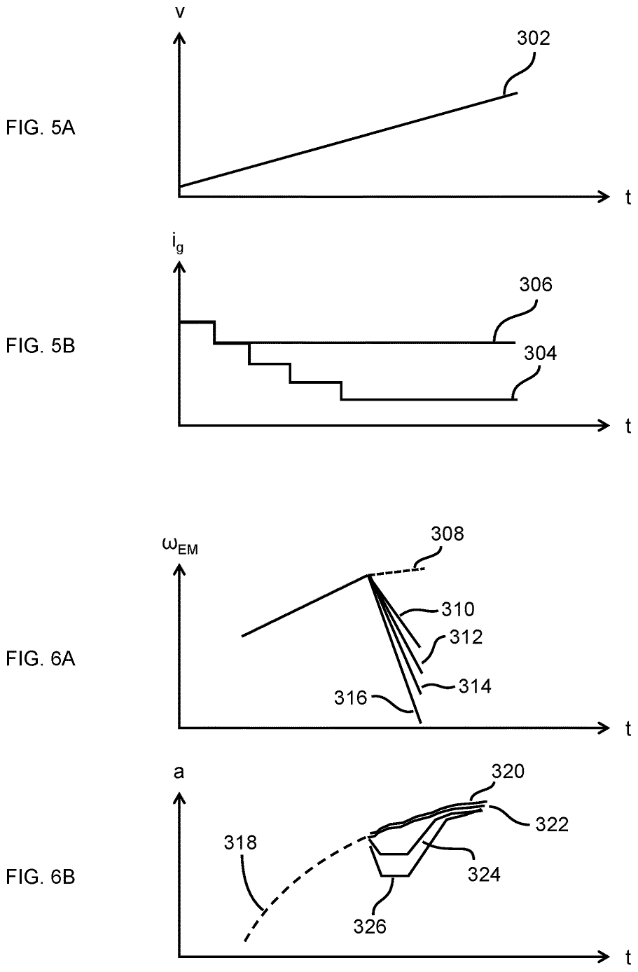

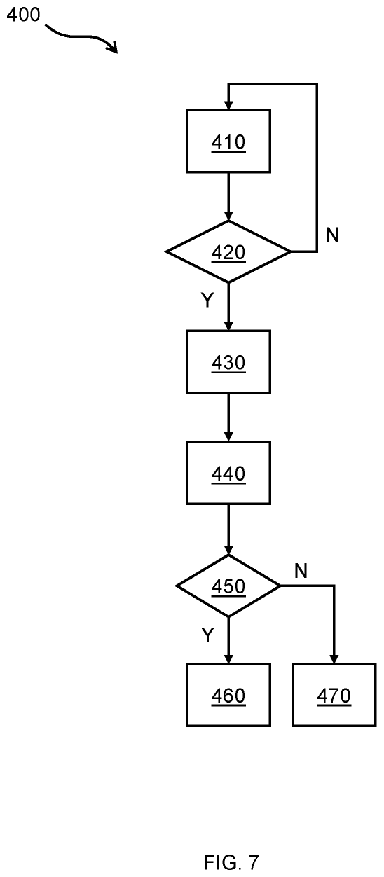

FIGS. 7 to 13 illustrate examples of a method 400 of controlling the automatic transmission 12 of the vehicle 1. The method 400 may be performed by the control system 100 illustrated in FIG. 3. In particular, the memory 108 may comprise computer-readable instructions 110 which, when executed by the processor 106, perform the method 400. The method 400 addresses a problem which will be explained now with reference to FIGS. 5A to 5B alongside FIGS. 6A to 6B.

FIG. 5A shows vehicle speed v on the y-axis with respect to time t on the x-axis. FIG. 5A depicts a linear increase in vehicle speed (line 302) with time. FIG. 5B shows gear ratio i_{g} on the y-axis with respect to time t on the x-axis. The lowest (smallest) gear ratio provides the fastest transmission output speed for a given transmission input speed. The highest (largest) gear ratio provides the slowest transmission output speed for a given transmission input speed. Upshifting reduces the gear ratio whilst downshifting increases the gear ratio.

FIG. 5B depicts the difference between a theoretical target gear ratio in a parallel hybrid mode (line 304) and a theoretical target gear ratio in an electric mode (line 306) over time as the vehicle speed increases. An electric machine 26 can be run at a higher speed than an engine 24, meaning that in the electric mode the automatic transmission 12 can remain in a higher gear ratio (lower gear) for given driving conditions (e.g., vehicle speed) than it could when the engine 24 is running in the parallel hybrid mode. It can be beneficial to efficiency and vehicle response to run the electric machine 26 at a higher speed than the engine 24 would be run.

When a transition from electric mode to parallel hybrid mode is requested, the engine 24 needs to start and connect to the driveline. To connect to the driveline, the engine speed needs to be synchronised with the driveline speed, which is dictated at this time by the electric machine speed and the on-going gear shift. To avoid high revving, excess fuel consumption, and noise, it may be preferable to allow the engine 24 to synchronise at as low a speed as possible. To this end, when transitioning from electric mode to parallel hybrid mode, a target gear ratio may be requested which is multiple steps lower than the current gear ratio in order to reduce the electric machine speed and thus the driveline speed.

Examples of the decrease in electric machine speed with different target gear ratios during an accelerative event (which is an event in which an electric to parallel hybrid transition may be triggered e.g., to have the engine 24 boost the wheel torque) is depicted in FIG. 6A which shows electric machine speed ω_{EM} on the y-axis with respect to time t on the x-axis. As can be seen in comparison to the electric machine speed in an initial gear ratio suitable for electric mode (line 308), successively lower gear ratio (lines 310-316) result in successively larger reductions in electric machine speed, thus providing for engine synchronisation at lower and lower speeds. However, reducing the electric machine speed by shifting to a lower gear ratio can result in a drop in the torque output from the electric machine 26. While the engine 24 is not yet connected to the driveline, the drop in the torque output from the electric machine 26 translates to a drop in wheel torque, which affects the longitudinal acceleration of the vehicle 1.

Examples of the effect on longitudinal acceleration of the vehicle 1 due to a drop in wheel torque is depicted in FIG. 6B which shows vehicle longitudinal acceleration a on the y-axis with respect to time t on the x-axis. As can be seen in comparison to the longitudinal acceleration in an initial gear ratio suitable for electric mode (line 318), the higher gear ratios closest to the initial gear ratio do not result in too pronounced of a dip in acceleration (lines 320, 322) whereas the lower gear ratios do result in a significant dip in acceleration (lines 324, 326) before the engine 24 is able to compensate.

FIG. 7 illustrates the method 400 of controlling the automatic transmission 12 of the vehicle 1. The method 400 determines permitted gear ratios during an electric to parallel hybrid mode transition by assessing the potential drop in wheel torque in one or more gear ratios. Block 410 comprises receiving an input signal indicative of a status of a propulsion system 22 of the vehicle 1. The status is indicative of which of the predefined operating modes the propulsion system 22 is in and between which predefined operating modes it is transitioning. Block 420 comprises determining whether the status is indicative of the propulsion system 22 being in transition from the electric mode to the parallel hybrid mode. If so (‘Y’ path from block 420), the method advances to block 430. If not (‘N’ path from block 420), the method 400 does not proceed further until such time as there is a transition from the electric mode to the parallel hybrid mode. Block 430 comprises obtaining a current wheel torque whereby, in conjunction with block 420, the current wheel torque represents the wheel torque at the beginning of the electric to parallel hybrid mode transition, T_{W_initial}. In some examples, the current wheel torque may be obtained by receiving an input signal indicative of the current wheel torque. In other examples, the current wheel torque may be obtained by receiving an input signal indicative of a current torque produced by an electric machine 26, T_{EM}, and determining the current wheel torque from this. For example, the current wheel torque may be determined by:

$${T}_{W \_ initial} = {T}_{E M} \cdot {i}_{EM} \cdot {i}_{g \_ current} \cdot {i}_{0} ,$$

where:
i_{EM} is a gear ratio between the electric machine 26 and the input shaft 18 of the automatic transmission 12 (which=1 if no gearing is provided between the electric machine 26 and the input shaft 18);
i_{g_current} is the current gear ratio; and
i₀ is a final drive ratio.

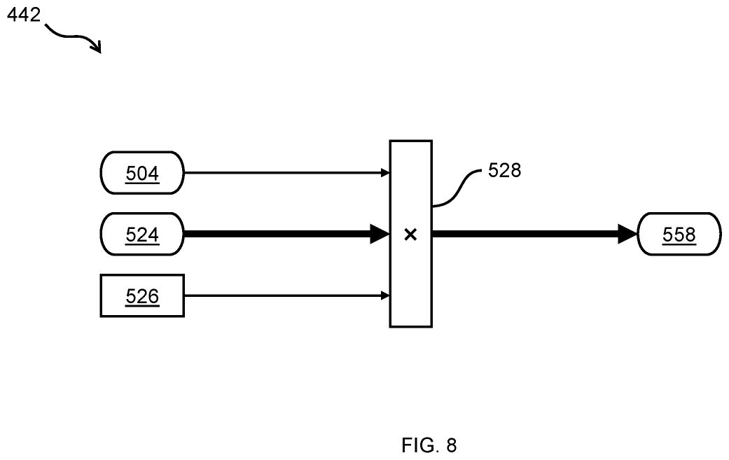

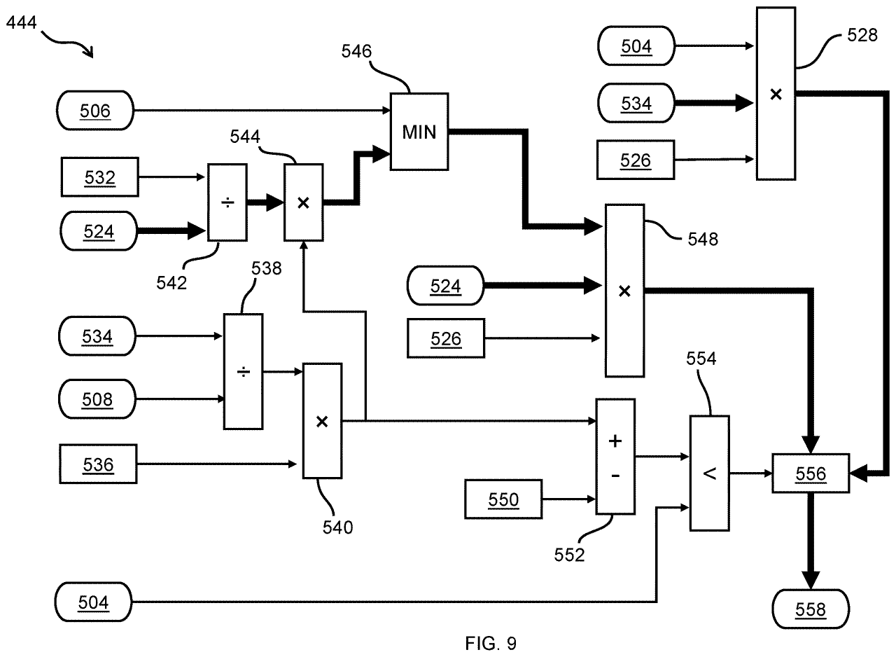

The current wheel torque may be stored, for example by latching, so that it can continue to be referenced at least throughout the electric to parallel hybrid mode transition. The current gear ratio may also be stored, for example by latching, so that it can continue to be referenced at least throughout the electric to parallel hybrid mode transition. Block 440 comprises determining an available wheel torque (T_{W})ⱼ in one or more gear ratios (i_{g})ⱼ which are selectable within the automatic transmission 12. In some examples, and as described further in relation to FIGS. 8 and 9, the available wheel torque (T_{W})ⱼ in one or more gear ratios (i_{g})ⱼ is determined based on the torque at the input shaft 18 of the automatic transmission 12 (sometimes referred to as the ‘powertrain torque’), whether the actual current value, T_{P_current}, which may be indicated by an input signal received by the control system 100, or a projected value, (T_{P_projected})ⱼ, which may be calculated on the basis of full power available with a given gear ratio (i_{g})ⱼ.

The available wheel torque (T_{W})ⱼ in the one or more gear ratios (i_{g})ⱼ may be given by multiplying the powertrain torque by respective ones of the one or more gear ratios (i_{g})ⱼ and by the final drive ratio i₀. For example:

$${( {T}_{W} )}_{j} = {T}_{P \_ current} \cdot {( {i}_{g} )}_{j} \cdot {i}_{0} , or$$

$${( {T}_{W} )}_{j} = {( {T}_{P \_ projected} )}_{j} \cdot {( {i}_{g} )}_{j} \cdot {i}_{0} .$$

In some examples, the method 400 may comprise selecting which of the current powertrain torque T_{P_current} and the projected powertrain torque (T_{P_projected})ⱼ to base the determination of the available wheel torque (T_{W})ⱼ in the one or more gear ratios (i_{g})ⱼ upon. This selection may depend on a power limit Pₗᵢₘ applied to the electric machine 26. The selection can depend on whether the power limit Pₗᵢₘ is more or less limiting to the power output of the electric machine 26 than a tuneable threshold. The selection can additionally or alternatively depend on how close the electric machine 26 is to operating at its power limit Pₗᵢₘ. For example, the available wheel torque (T_{W})ⱼ in the one or more gear ratios (i_{g})ⱼ may be determined based on the current powertrain torque T_{P_current} (rather than the projected powertrain torque (T_{P_projected})ⱼ) if a power limit Pₗᵢₘ applied to the electric machine 26 is less limiting than a tuneable threshold for the limit (as in, if the electric machine 26 is determined to still, in view of any power limit applied thereto, be able to provide a power output which exceeds a tuneable threshold). The available wheel torque (T_{W})ⱼ in the one or more gear ratios (i_{g})ⱼ may be determined based on the projected powertrain torque (T_{P_projected})ⱼ (rather than the current powertrain torque T_{P_current}) if the electric machine 26 is operating close to its power limit Pₗᵢₘ (as in, if the current powertrain torque T_{P_current} is within a tuneable offset of the maximum powertrain torque currently available, given current gear ratio and any current power limit).

Block 450 comprises determining whether the available wheel torque (T_{W})ⱼ in a given gear ratio (i_{g})ⱼ exceeds a predefined fraction α of the obtained wheel torque T_{W_initial} (from block 430). The predefined fraction α may be calibrated to balance what may be acceptable in terms of drop in wheel torque against what is acceptable in terms of increased engine 24 speed, excess fuel consumption, noise and time to reach sync speed (complete the mode transition). The exact fraction will depend on the characteristics of individual powertrains including the characteristics of engines, electric machines, automatic transmissions, and the like. The exact fraction may also depend on vehicle characteristics because the mass and aerodynamics of the vehicle 1 will have a large effect on the road load torque (torque required for 0 acceleration at a given speed).

If the available wheel torque (T_{W})ⱼ in a given gear ratio (i_{g})ⱼ does exceed the predefined fraction α of the obtained wheel torque T_{W_initial} (‘Y’ path from block 450), the method 400 advances to block 460. Block 460 comprises permitting shifting to the given gear ratio (i_{g})ⱼ. If the available wheel torque (T_{W})ⱼ in the given gear ratio (i_{g})ⱼ is less than or equal to the predefined fraction α of the obtained wheel torque T_{W_initial} (‘N’ path from block 450), the method 400 advances to block 470. Block 470 comprises inhibiting shifting to the given gear ratio (i_{g})ⱼ.

Blocks 450-470 can be repeated in respect of each gear ratio (i_{g})ⱼ for which an available wheel torque (T_{W})ⱼ was determined at block 430. Accordingly, shifting to any of the one or more gear ratios (i_{g})ⱼ in which the available wheel torque (T_{W})ⱼ exceeds the predefined fraction α of the obtained wheel torque T_{W_initial} is permitted and shifting to any of the one or more gear ratios (i_{g})ⱼ in which the available wheel torque (T_{W})ⱼ is less than or equal to the predefined fraction α of the obtained wheel torque (T_{W})ᵢₙᵢₜᵢₐₗ is inhibited. In some examples, there may be a specific predefined fraction αₜ for each of the one or more gear ratios (i_{g})ⱼ. Therefore, the fraction of the obtained wheel torque T_{W_initial} which must be exceed for a given gear ratio (i_{g})ⱼ to be permitted can depend on and vary with the gear ratio (i_{g})ⱼ.

In some examples, the method 400 continues to determine an available wheel torque (T_{W})ⱼ in one or more gear ratios (i_{g})ⱼ and continues to inhibit shifting to any of the one or more gear ratios (i_{g})ⱼ in which the available wheel torque (T_{W})ⱼ does not exceed the predefined fraction α of the obtained wheel torque (T_{W})ᵢₙᵢₜᵢₐₗ while the propulsion system 22 is in transition from the electric mode to the parallel hybrid mode and for a predefined period following completion of the transition into the parallel hybrid mode. The predefined period may be of sufficient duration to enable the engine 24 operation to stabilise to the point where it can compensate for the drop in wheel torque available from the electric machine 26 alone if an upshift were to be completed.

In the following FIGS. 8 to 12, arrows indicate the passing of values from one operation/process (block) to the next. Thick arrows indicate a vector and thin arrows indicate a scalar. FIG. 8 illustrates an example of a first method 442 of determining the available wheel torque (T_{W})ⱼ in one or more gear ratios (i_{g})ⱼ which are selectable within the automatic transmission 12, as required at block 440 of the method 400.

In this method 442, a current powertrain torque T_{P_current} is received as an input parameter at block 504. The current powertrain torque T_{P_current} may be indicated by a signal received by the control system 100 or may be an output parameter from another method performed by the control system 100. A gear ratio vector i_{g}, where each element of the vector is a different one of the one or more gear ratios (i_{g})ⱼ, is obtained at block 524. The gear ratio vector i_{g} may be obtained by accessing data on the gear ratios (i_{g})ⱼ which are selectable within the automatic transmission 12 from the memory 108 of the control system 100. Obtaining the gear ratio vectors i_{g} may also involve operations such as calculating or computing or selecting or choosing. Alternatively, the gear ratio vector i_{g} may be received as an input parameter to the method 442.

The final drive ratio i₀ is obtained at block 526. This too may be obtained by accessing data on the final drive ratio i₀ from the memory 108 of the control system 100 and may also involve operations such as calculating or computing or selecting or choosing. Each element of the gear ratio vector i_{g} is multiplied by the current powertrain torque T_{P_current} and the final drive ratio i₀ at block 528, resulting in a vector of available wheel torques T_{W}, where each element of the vector is an available wheel torque (T_{W})ⱼ in a different one of the one or more gear ratios (i_{g})ⱼ. The available wheel torque (T_{W})ⱼ in a given gear ratio (i_{g})ⱼ is given by:

$${( {T}_{W} )}_{j} = {T}_{P \_ current} \cdot {( {i}_{g} )}_{j} \cdot {i}_{0} .$$

The vector of available wheel torques T_{W} is provided as an output parameter from the method 442 at block 530. It will be understood that this may not be an output from the control system 100. It may be used by one or more other methods performed by the control system 100 to derive an output from the control system 100.

FIG. 9 illustrates an example of a second method 444 of determining the available wheel torque (T_{W})ⱼ in one or more gear ratios (i_{g})ⱼ which are selectable within the automatic transmission 12, as required at block 440 of the method 400. This method 444 determines the available wheel torque (T_{W})ⱼ in the one or more gear ratios (i_{g})ⱼ in two different ways and, at block 558, selects between the results based on whether or not the current powertrain torque T_{P_current} is close to the maximum powertrain torque currently available in the current gear ratio i_{g_current} if full power is used with the current gear ratio i_{g_current}. If the current powertrain torque T_{PC_current} is close to this maximum powertrain torque currently available in the current gear ratio i_{g_current}, torque output from the electric machine 26 is more likely to be limited by a power limit Pₗᵢₘ which is applied to the electric machine 26. Therefore, one determination of the available wheel torque (T_{W})ⱼ in the one or more gear ratios (i_{g})ⱼ by the method 444 is configured to take account of this.

A first determination of the available wheel torque (T_{W})ⱼ in the one or more gear ratios (i_{g})ⱼ by the method 444 is based on the projected powertrain torque (T_{P_projected}); in each of the one or more gear ratios (i_{g})ⱼ. The result of this determination is selected for use when the current powertrain torque T_{P_current} is close to the maximum powertrain torque currently available in the current gear ratio i_{g_current}. The first determination of the available wheel torque (T_{W})ⱼ in the one or more gear ratios (i_{g})ⱼ by the method 444 will now be described in more detail.

A power limit Pₗᵢₘ applied to the electric machine 26 is received as an input parameter at block 534. It will be understood that this is an input parameter to the method 444 and not necessarily an input to the control system 100. Nevertheless, an input signal which is at least indirectly indicative of the power limit Pₗᵢₘ applied to the electric machine 26 can be received as an input signal by the control system 100. For example, the control system 100 may receive an input signal indicative of the powertrain performance ratio from, for example, a powertrain control module (PCM) of the vehicle 1 or from a vehicle supervisory controller (VSC) of the vehicle 1, which may be employed to coordinate control between the conventional powertrain and the electrified powertrain. The VSC may be hosted within the PCM. The powertrain performance ratio is a dimensionless value which characterises the relative performance of electrified powertrain components, in respect to their optimum performance, due to the effect of electrical power limits. Another method performed by the control system 100 may determine the power limit Pₗᵢₘ applied to the electric machine 26 based on the powertrain performance ratio. For example, a lookup table stored in the memory 108 of the control system 100 may define power limits applied to the electric machine 26 for different powertrain performance ratios. Accordingly, the received powertrain performance ratio may be used as an index to the lookup table to extract the corresponding power limit Pₗᵢₘ.

A current speed ω_{EM_current} of the electric machine 26 is received as an input parameter at block 508. The current speed ω_{EM_current} of the electric machine 26 may be indicated by a signal received by the control system 100 or may be an output parameter from another method performed by the control system 100. The gear ratio i_{EM} between the electric machine 26 and the input shaft 18 of the automatic transmission 12 is obtained at block 536. This may be obtained by accessing data on this gear ratio i_{EM} from the memory 108 of the control system 100 and may also involve operations such as calculating or computing or selecting or choosing.

The power limit Pₗᵢₘ applied to the electric machine 26 is divided by the current speed ω_{EM_current} of the electric machine 26 at block 538 and the result of block 538 is multiplied by the gear ratio i_{EM} between the electric machine 26 and the input shaft 18 of the automatic transmission 12 at block 540. The result of this multiplication is the maximum powertrain torque currently available in the current gear ratio i_{g_current}. The current gear ratio i_{g_current} is obtained at block 532. This may be obtained by accessing data on this gear ratio i_{g_current} from the memory 108 of the control system 100 and may also involve operations such as calculating or computing or selecting or choosing.

A vector of relative gear ratios is obtained by dividing the current gear ratio i_{g_current} by each element, (i_{g})ⱼ, of the gear ratio vector i_{g} (which is determined at block 524 in the manner previously described) at block 542. Each element of the resultant vector of relative gear ratios is multiplied by the maximum powertrain torque currently available in the current gear ratio i_{g_current} (the result of block 540) at block 544. The resultant vector constitutes an initial determination of the projected powertrain torque T_{P_projected} in each of the one or more gear ratios (i_{g})ⱼ, where each element of the vector is a projected powertrain torque (T_{P_projected})ⱼ, in a different one of the one or more gear ratios (i_{g})ⱼ.

A target powertrain torque T_{P_target} based on an accelerator input, is received as an input parameter at block 506. The target powertrain torque T_{P_target} can be indicated by a signal received by the control system 100 or may be an output parameter of another method performed by the control system 100 using other input signals received by the control system 100 such as, for example, an input signal indicative of the accelerator input. The accelerator input may represent, for example, accelerator pedal depression (APD) or autonomous driving torque demand from an automated driving system (ADS).

A final determination of the projected powertrain torque T_{P_projected} comprises comparing each element of the vector constituting an initial determination of the projected powertrain torque in each of the one or more gear ratios (the result of block 544) with the target powertrain torque T_{P_target} in order to return a new vector comprising the element-wise minima at block 546. This new vector constitute a final determination of the projected powertrain torque in each of the one or more gear ratios T_{P_projected}, where each element of the vector is a projected powertrain torque (T_{P_projected})ⱼ in a different one of the one or more gear ratios (i_{g})ⱼ.

An element-wise product of the projected powertrain torque in each of the one or more gear ratios T_{P_projected}, the gear ratio vector i_{g}, and the final drive ratio i₀ (which is obtained at block 526 in the manner previously described) is determined at block 548, resulting in a vector of available wheel torques T_{W} where each element of the vector is an available wheel torque (T_{W})ⱼ in a different one of the one or more gear ratios (i_{g})ⱼ. The available wheel torque (T_{W})ⱼ in a given gear ratio (i_{g})ⱼ according to the first determination is therefore given by:

$${( {T}_{W} )}_{j} = {( {T}_{P \_ projected} )}_{j} \cdot {( {i}_{g} )}_{j} \cdot {i}_{0} ,$$

$$where {( {T}_{P \_ projected} )}_{j} = min \{ ( {P}_{lim} \cdot {i}_{EM} ) / {( {ω}_{EM \_ expected} )}_{j} , {T}_{P \_ target} \} ,$$

where (ω_{EM_expected})ⱼ is the expected speed of the electric machine 26 at the current vehicle speed for a given gear ratio and is given by:

$${( {ω}_{EM \_ expected} )}_{j} = {ω}_{EM \_ current} \cdot ( {( {i}_{g} )}_{j} / {i}_{g \_ current} ) .$$

It will be appreciated that the first determination of the available wheel torque (T_{W})ⱼ in the one or more gear ratios (i_{g})ⱼ may be determined by a different arrangement of blocks whereby, for example, a vector of the expected speed of the electric machine ω_{EM_expected}, at the current vehicle speed, for each of the one or more gear ratios (i_{g})ⱼ may be determined first and, subsequently, the initial determination of the projected powertrain torque T_{P_projected} in each of the one or more gear ratios (i_{g})ⱼ may be determined using this vector ω_{EM_expected}.

A second determination of the available wheel torque (T_{W})ⱼ in the one or more gear ratios (i_{g})ⱼ by the method 444 is based on the current powertrain torque T_{P_current} in essentially the same way as the method 442 of FIG. 8. The result of this determination is selected for use when the current powertrain torque T_{P_current} is not close to the maximum powertrain torque currently available in the current gear ratio i_{g_current}. The criterion for selecting between the results of the first and second determination will now be explained in more detail.

A tuneable offset is obtained at block 550. This may be obtained by accessing data from the memory 108 of the control system 100 and may also involve operations such as calculating or computing or selecting or choosing. The tuneable offset defines what is meant by close when in the foregoing reference has been made to the current powertrain torque T_{P_current} being or not being close to the maximum powertrain torque currently available in the current gear ratio i_{g_current}. The tuneable offset is subtracted from the maximum powertrain torque currently available in the current gear ratio (the result of block 540) at block 552.

The result of block 552 is compared to the current powertrain torque T_{P_current} (which is obtained as an input at block 504 in the manner previously described) at block 554 to determine if the current powertrain torque T_{P_current} is within a tuneable offset of, and therefore close to, the maximum powertrain torque currently available in the current gear ratio i_{g_current}. If the result of block 554 indicates that the current powertrain torque T_{P_current} is within a tuneable offset of the maximum powertrain torque currently available in the current gear ratio i_{g_current}, the result of the first determination of the available wheel torque (T_{W})ⱼ in the one or more gear ratios (i_{g})ⱼ is selected at block 556. On the other hand, if the result of block 554 indicates that the current powertrain torque T_{P_current} is not within a tuneable offset of the maximum powertrain torque currently available in the current gear ratio i_{g_current}, the result of the second determination of the available wheel torque (T_{W})ⱼ in the one or more gear ratios (i_{g})ⱼ is selected at block 556.

Depending on the selection at block 556, the corresponding vector of available wheel torques T_{W} is provided as an output at block 558. It will be understood that this is an output of the method 444, not an output from the control system 100. It may be used by one or more other methods performed by the control system 100 to derive an output from the control system 100. In other, essentially equivalent examples, rather than selecting between the results of the two determinations at block 556, the selection may be between which determination to perform.

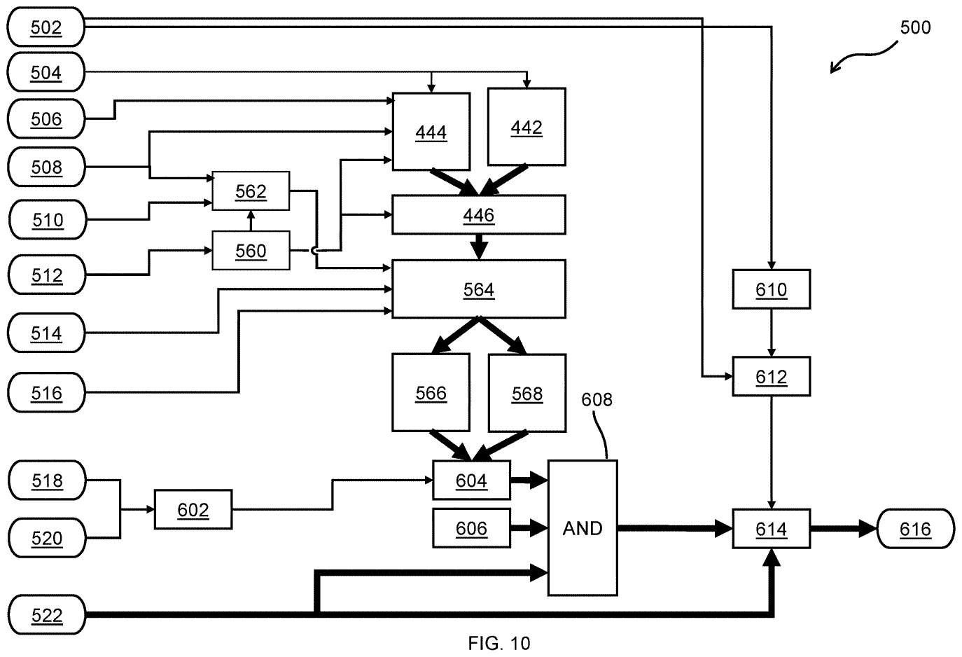

FIG. 10 illustrates an example of a method 500 upon which the method 400 may, in some examples, rely for the performance of blocks 440 and 450.

The method 500 comprises receiving at least some of the following as input parameters:
a status of the propulsion system 22, received at block 502;
a current powertrain torque T_{P_current}, received at block 504;
a target powertrain torque T_{P_target} based on an accelerator input, received at block 506;
a current speed ω_{EM_current} of the electric machine 26, received at block 508;
a maximum available electric machine torque T_{EM_received_max}, received at block 510;
a powertrain performance ratio, received at block 512;
a wheel torque demand T_{W_demand}, received at block 514;
an obtained wheel torque T_{W_initial}, received at block 516;
a target powertrain torque delta, received at block 518;
a target powertrain torque gradient, received at block 520; and
a vector A defining which of the gear ratios, which are selectable within the automatic transmission 12, are currently allowed, received at block 522.

These input parameters may be indicated by signals received by the control system 100 or may be output parameters from another method performed by the control system 100. They may therefore be received from an external source (with respect to the to the control system 100) or have an internal source. For example, the wheel torque demand T_{W_demand}, may be calculated by another method performed by the control system 100 from the target powertrain torque T_{P_target}, multiplied by the current gear ratio i_{g_current}, multiplied by the final drive ratio i₀.

For example, the obtained wheel torque T_{W_initial} may be calculated by another method implemented by the control system 100 from the current torque T_{EM_current} produced by the electric machine 26, multiplied by a gear ratio i_{EM} between the electric machine 26 and the input shaft 18 of the automatic transmission 12, multiplied by the current gear ratio i_{g_current}, multiplied by the final drive ratio i₀, as described in relation to FIG. 7.

The vector A defines which of the gear ratios are currently allowed according to other methods which have already been performed by the control system 100. It is therefore not received as an input to the control system 100, but rather has an internal source. Certain gears may not be allowed due to a transmission malfunction or a certain operating condition under which excessive wear and/or damage may occur to a given gear, for example after extended operation in a specific gear the cancellers for unused clutches may drain down. Performing a shift into another specific gear at this point could cause a high speed gradient on a clutch basket for a clutch not used in the shift, leading to a scenario where this clutch self applies leading to excessive heat generation and clutch failure due to lack of pressure on the clutch canceller.

Block 560 comprises determining the power limit Pₗᵢₘ applied to the electric machine 26 based on the powertrain performance ratio obtained as an input at block 512. For example, a lookup table stored in the memory 108 of the control system 100 may define power limits applied to the electric machine 26 for different powertrain performance ratios. Accordingly, the powertrain performance ratio obtained as an input at block 512 may be used as an index to the lookup table to extract the corresponding power limit Pₗᵢₘ. The power limit Pₗᵢₘ is then provided as an input to blocks 444 and 446.

In this example, the determination of the available wheel torque (T_{W})ⱼ in one or more gear ratios (i_{g})ⱼ which are selectable within the automatic transmission 12, as required at block 440 of the method 400, is provided by three blocks: block 442, representing method 442 illustrated in FIG. 8; block 444, representing method 444 illustrated in FIG. 9; and block 446, comprising a selection between methods 442 and 444 or between their output parameters T_{W}. This selection depends on the power limit Pₗᵢₘ applied to the electric machine 26.

Specifically, block 446 comprises determining whether the power limit Pₗᵢₘ is more or less limiting to the power output of the electric machine 26 than a tuneable threshold and selecting between methods 442 and 444 or between their output parameters T_{W} on the basis of the determination.

If the power limit Pₗᵢₘ applied to the electric machine 26 is less limiting than a tuneable threshold for the limit (as in, if the electric machine 26 is determined to still, in view of any power limit applied thereto, be able to provide a power output which exceeds a tuneable threshold), then block 446 selects to perform a determination of the available wheel torque in each of the one or more gear ratios T_{W} using method 442 (instead of method 444) or selects to accept the output parameter from method 442 as the available wheel torque in each of the one or more gear ratios T_{W}.

If the power limit Pₗᵢₘ applied to the electric machine 26 is more limiting than a tuneable threshold for the limit (as in, if the electric machine 26 is determined to be unable to provide a power output which exceeds a tuneable threshold), then block 446 selects to determine the available wheel torque in each of the one or more gear ratios T_{W} using method 444 or selects to accept the output parameter from method 444 as the available wheel torque in each of the one or more gear ratios T_{W}.

The selected available wheel torque in each of the one or more gear ratios T_{W} is provided as an input parameter to block 564. The obtained wheel torque T_{W_initial} (obtained at block 516) is also provided as an input parameter to block 564. Block 564 comprises calculating a first ratio vector R1, where each element R1ⱼ is calculated as

the available wheel torque in a given gear ratio (T_{W})ⱼ divided by obtained wheel torque T_{W_initial}. That is:

$$R {1}_{j} = {( {T}_{W} )}_{j} / {T}_{W \_ initial} .$$

The ratio R1 can then be used to assess which of the one or more gear ratios (i_{g})ⱼ should be permitted on the basis of the available wheel torque (T_{W})ⱼ in respective gear ratios (i_{g})ⱼ. In some examples, permitted shifting is further limited to those of the one or more gear ratios (i_{g})ⱼ in which the available wheel torque (T_{W})ⱼ exceeds at least one from the following: a predefined fraction of the wheel torque demand T_{W_demand}; a predefined fraction of the available wheel torque in a current gear ratio T_{W_current_max}. To this end, in the example of method 500, more than one ratio is calculated at block 564. These additional ratios may be used to assess whether to further limit the gear ratios (i_{g})ⱼ to which shifting is permitted. For example, block 564 can also comprise calculating a second ratio vector R2, where each element R2ⱼ is calculated as the available wheel torque (T_{W})ⱼ in a given gear ratio (i_{g})ⱼ, divided by the wheel torque demand T_{W_demand}. That is:

$$R {2}_{j} = {( {T}_{W} )}_{j} / {T}_{W \_ demand} .$$

Block 564 can also comprise calculating a third ratio vector R3, where each element R3ⱼ is calculated as the available wheel torque (T_{W})ⱼ in a given gear ratio (i_{g})ⱼ, divided by an available wheel torque in the current gear ratio T_{W_current_max}. That is:

$$R {3}_{j} = {( {T}_{W} )}_{j} / {T}_{W \_ current \_ max} .$$

The available wheel torque in the current gear ratio T_{W_current_max} is determined at block 562. Block 562 comprises comparing the maximum available electric machine torque T_{EM_received_max} (received at block 510) with an inferred maximum available electric machine torque T_{EM_inferred_max}, which is calculated from the power limit Pₗᵢₘ applied to the electric machine 26 (obtained at block 560) divided by the current speed ω_{EM_current} of the electric machine 26 (received at block 508). The minimum between these is multiplied by the gear ratio i_{EM} between the electric machine 26 and the input shaft 18 of the automatic transmission 12, the current gear ratio i_{g_current}, and the final drive ratio i₀ to arrive at a value for the available wheel torque in the current gear ratio T_{W_current_max}. That is:

$${T}_{W\_current \_max} = min \{ {T}_{EM\_received \_max} , ( {P}_{lim} / {ω}_{EM\_current} ) \} \cdot {i}_{E M} \cdot {i}_{g\_current} \cdot {i}_{0} .$$

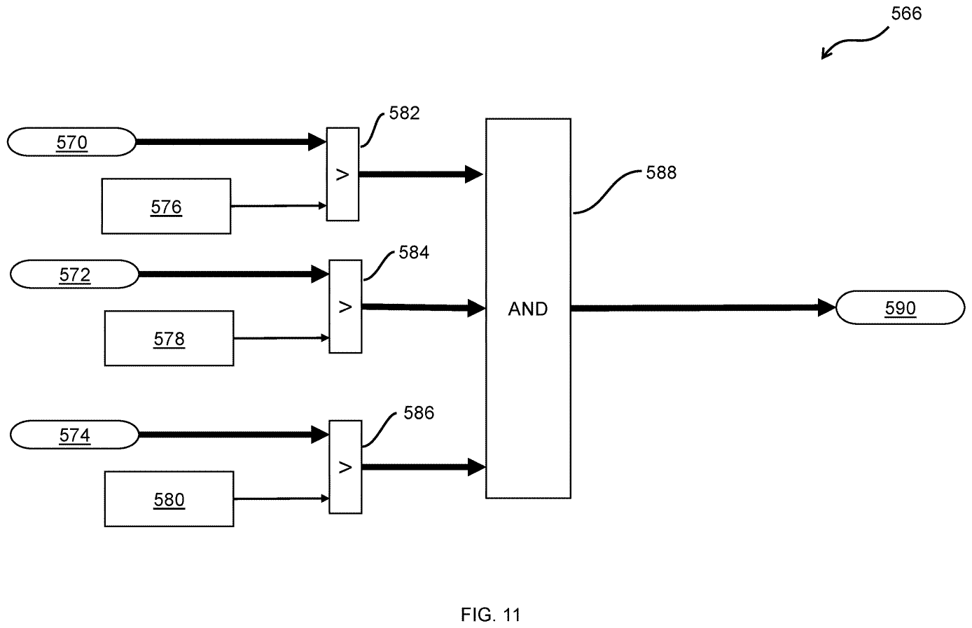

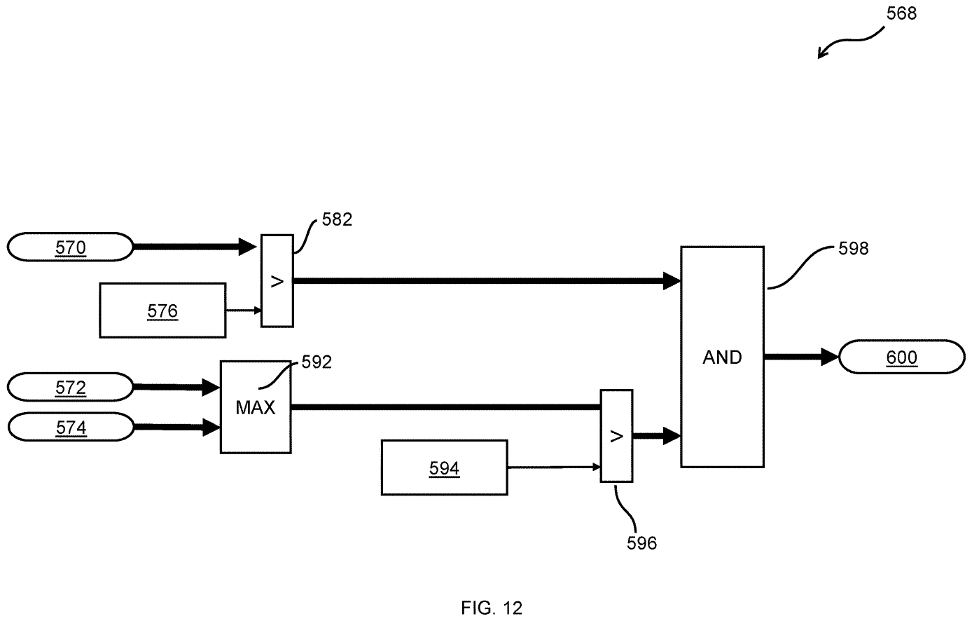

The ratios R1, R2, and R3 calculated at block 564 are provided to one or both of blocks 566 and 568. Blocks 566 and 568 assess which of the one or more gear ratios (i_{g})ⱼ should be permitted on the basis of the available wheel torque (T_{W})ⱼ in respective gear ratios (i_{g})ⱼ using the ratios R1, R2, and R3. Block 566 makes an assessment appropriate for a scenario in which there is an increasing load. Block 568 makes an assessment appropriate for a scenario in which there is a constant load or near constant load. FIG. 11 illustrates an example of constituent blocks comprised in block 566. The ratios R1, R2, and R3 are received (from block 564) as input parameters at blocks 570, 577 and 574 respectively. A minimum threshold value α for R1ⱼ is obtained at block 576, for example by accessed data on this minimum threshold value from the memory 108 of the control system 100.

Block 582 comprises comparing each element R1ⱼ, of R1 with the minimum threshold value α to determine which is greater and return a logical vector L1 where each element L1ⱼ is from the Boolean domain {0,1} and effectively indicates whether or not the available wheel torque (T_{W})ⱼ in a given gear ratio (i_{g})ⱼ exceeds a predefined fraction α of the obtained wheel torque T_{W_initial}. A minimum threshold value β for R2ⱼ is obtained at block 578, for example by accessed data on this minimum threshold value from the memory 108 of the control system 100.

Block 584 comprises comparing each element R2ⱼ of R2 with the minimum threshold value β to determine which is greater and return a logical vector L2 where each element L2ⱼ is from the Boolean domain {0,1} and effectively indicates whether or not the available wheel torque (T_{W})ⱼ in a given gear ratio (i_{g})ⱼ exceeds a predefined fraction β of the wheel torque demand T_{W_demand}. A minimum threshold value γ for R2ⱼ is obtained at block 580, for example by accessed data on this minimum threshold value from the memory 108 of the control system 100.

Block 586 comprises comparing each element R3ⱼ of R3 with the minimum threshold value γ to determine which is greater and return a logical vector L3 where each element L3ⱼ is from the Boolean domain {0,1} and effectively indicates whether or not the available wheel torque (T_{W})ⱼ in a given gear ratio (i_{g})ⱼ exceeds a predefined fraction γ of the available wheel torque in the current gear ratio T_{W_current_max}. Block 588 comprises applying an element-wise logical AND operation on L1, L2, and L3 to return another logical vector G such that:

$${G}_{j} = L {1}_{j} ∧ L {2}_{j} ∧ L {3}_{j}$$

The logical vector G represents an initial determination of permitted gear ratios. A given gear ratio (i_{g})ⱼ is indicated as permissible if element Gⱼ=1. This occurs only if L1ⱼ, L2ⱼ, and L3ⱼ each=1. Thus, this occurs for gear ratios (i_{g})ⱼ in which the available wheel torque (T_{W})ⱼ exceeds: a predefined fraction α of the obtained wheel torque T_{W_initial}, a predefined fraction β of the wheel torque demand T_{W_demand}, and a predefined fraction γ of the available wheel torque in a current gear ratio T_{W_current_max}.

A given gear ratio (i_{g})ⱼ is indicated as impermissible if element Gⱼ=0. This occurs if any one or more of L1ⱼ, L2ⱼ, and L3ⱼ=0. Thus, this occurs for gear ratios (i_{g})ⱼ in which the available wheel torque (T_{W})ⱼ is less than or equal to one or more of: a predefined fraction α of the obtained wheel torque T_{W_initial}, a predefined fraction β of the wheel torque demand T_{W_demand}, and a predefined fraction γ of the available wheel torque in a current gear ratio T_{W_current_max}. The initial determination of permitted gear ratios G is provided as an output parameter (from block 566) at block 590. It will be understood that this output parameter forms an input parameter for another block in the method 500 (specifically block 604) and is not an output from the control system 100.

FIG. 12 illustrates an example of constituent blocks comprised in block 568. The ratios R1, R2, and R3 are received (from block 564) as input parameters at blocks 570, 577 and 574 respectively. The minimum threshold value α for R1ⱼ is obtained at block 576, as described in relation to the example of FIG. 11. The logical vector L1 is returned by block 582, as described in relation to the example of FIG. 11. Block 592 comprises comparing each element of R2 with the corresponding element of R3 in order to return a new vector comprising the element-wise maxima. Block 596 comprises comparing each element max {R2ⱼ, R3ⱼ} of this new vector with a minimum threshold value δ to determine which is greater and return a logical vector L4 where each element L4j is from the Boolean domain {0,1} and effectively indicates whether or not the available wheel torque (T_{W})ⱼ in a given gear ratio (i_{g})ⱼ exceeds at least one of: a predefined fraction δ of the wheel torque demand T_{W_demand} or the predefined fraction δ of the available wheel torque in a current gear ratio T_{W_current_max}.

The minimum threshold value δ for max {R2ⱼ, R3ⱼ} is obtained at block 594, for example by accessed data on this minimum threshold value from the memory 108 of the control system 100. Block 598 comprises applying an element-wise logical AND operation on L1 and L4 to return another logical vector G such that:

$${G}_{j} = L {1}_{j} ∧ L {4}_{j}$$

The logical vector G represents an initial determination of permitted gear ratios. A given gear ratio (i_{g})ⱼ is indicated as permissible if element Gⱼ=1. This occurs only if L1ⱼ and L4ⱼ both=1. Thus, this occurs for gear ratios (i_{g})ⱼ in which the available wheel torque (T_{W})ⱼ exceeds: a predefined fraction α of the obtained wheel torque T_{W_initial} and at least one of: a predefined fraction δ of the wheel torque demand T_{W_demand} or the predefined fraction δ of the available wheel torque in a current gear ratio T_{W_current_max}.

A given gear ratio (i_{g})ⱼ is indicated as impermissible if element Gⱼ=0. This occurs if any one or more of L1ⱼ and L4ⱼ=0. Thus, this occurs for gear ratios (i_{g})ⱼ in which the available wheel torque (T_{W})ⱼ is either less than or equal to a predefined fraction α of the obtained wheel torque T_{W_initial} or is less than or equal to both a predefined fraction δ of the wheel torque demand T_{W_demand} and the predefined fraction δ of the available wheel torque in a current gear ratio T_{W_current_max}.

The initial determination of permitted gear ratios G is provided as an output parameter (from block 568) at block 600. It will be understood that this output parameter forms an input parameter for another block in the method 500 (specifically block 604) and is not an output from the control system 100. In some examples, the minimum thresholds (predefined fractions) α, β, γ, and δ can each comprise a set of values instead of a single value. In a set of values, there may be a specific value for each of the one or more gear ratios (i_{g})ⱼ. These sets of values may be provided in the form of vectors α, β, γ, and δ. Comparisons with ratios R1, R2, and R3 will, in such examples, be performed element-wise.

Returning to FIG. 10, block 604 comprises determining whether there is an increasing load or a constant (or near constant) load and selecting, on the basis of the determination, between performance of block 566 or the performance of block 568 or between use of the output parameter from block 566 or use of the output parameter from block 568. The load is assessed based on either a target powertrain torque delta (received at block 518) or a target powertrain torque gradient (received at block 520).

The target powertrain torque delta is indicative of the amount by which the wheel torque demand T_{W_demand} has changed since it was determined that the propulsion system 22 is in transition from the electric mode to the parallel hybrid mode. The target powertrain torque gradient is indicative of the rate at which the wheel torque demand T_{W_demand} has changed over a tuneable time period.

In some, but not necessarily all, examples the method 500 comprises block 602 which enables switching of which of these two input parameters will be used to assess the load. In other examples, only one of these may be an input parameter to the method 500 and the load will be assessed on the basis of just that parameter. Block 604 determines that the load is increasing if the target powertrain torque delta is greater than or equal to a threshold amount or if the target powertrain torque gradient is greater than or equal to a threshold rate. This is indirectly a determination of whether the wheel torque demand is increasing by at least a threshold amount or at at least a threshold rate. If it is determined that the load is increasing, block 604 selects to perform an initial determination of permitted gear ratios G using block 566 (instead of block 568) or selects to accept the output of block 566 (instead of the output of block 568) as the initial determination of permitted gear ratios G which is then provided to block 608.

Block 604 determines that the load is constant or near constant if the target powertrain torque delta is less than a threshold amount or if the target powertrain torque gradient is less than or a threshold rate. This is indirectly a determination of whether the wheel torque demand is increasing by less than a threshold amount or at less than a threshold rate. If it is determined that the load is constant or near constant, block 604 selects to perform an initial determination of permitted gear ratios G using block 568 (instead of block 566) or selects to accept the output of block 568 (instead of the output of block 566) as the initial determination of permitted gear ratios G which is then provided to block 608.

In some examples, the method 500 may filter out gear ratios (i_{g})ⱼ which are not allowed according to other methods which have already been performed by the control system 100 and those to which a direct shift cannot be performed from the current gear ratio i_{g_current} due to limitations of the hardware which might arise as a result the arrangement of gears in the gear set 16 or manner in which the shifting mechanism works.

This can be achieved by block 608. Block 608 comprises applying an element-wise logical AND operation to:
the initial determination of permitted gear ratios G;
The vector A defining which of the gear ratios (i_{g})ⱼ are currently allowed (received at block 522); and
a vector S defining which of the gear ratios (i_{g})ⱼ are possible via direct shift from the current gear ratio i_{g_current}.

The vector S can be obtained from a lookup table stored in the memory 108 of the control system 100 which defines the possible gear shifts from each of the gear ratios. Accordingly, the current gear ratio i_{g_current} may be used as an index to the lookup table to extract the vector S. Block 608 therefore finalised the determination of permitted gear ratios. The finalised determination of permitted gear ratios G′ is output at block 616. It will be understood that this is an output of the method 500, not an output from the control system 100. It may be used by one or more other methods performed by the control system 100 to derive an output from the control system 100.

The method 500 can be enabled, and the output at block 616 provided, when the status of the propulsion system 22 (received at block 502) indicates that the propulsion system 22 is in transition from the electric mode to the parallel hybrid mode. This ensures that gear ratios (i_{g})ⱼ which would provide too significant of a drop in wheel torque continue to be identified throughout the transition and can be prevented. In some examples, the method 500 can be enabled, and the output at block 616 provided, during a predefined period following completion of the transition into the parallel hybrid mode.

Block 610 comprises a timer which is activated when the status of the propulsion system 22 changes from indicating that the propulsion system 22 is in transition from the electric mode to the parallel hybrid mode to indicating that the propulsion system 22 is in the parallel hybrid mode. The timer will count down from a predefined value such that it expires after the predefined period. The timer can be reset if the status of the propulsion system 22 changes to indicate that the propulsion system 22 is in the electric mode or is in transition from the parallel hybrid mode to the electric mode.

Block 612 comprises determining if either the propulsion system 22 is in transition from the electric mode to the parallel hybrid mode or if the timer of block 610 is running. If so block 614 enables the passing of the permitted gear ratios G′ to block 616 for output. If not, block 614 does not enable the passing of the permitted gear ratios G′ to block 616 for output and so no output from the method 500 is provided.

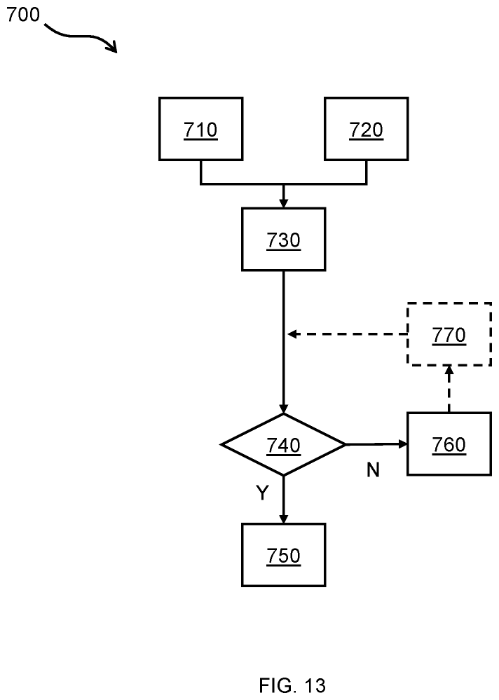

FIG. 13 illustrates an example of a method 700 upon which the method 400 may, in some examples, rely for the performance of blocks 460 and 470 (permitting and inhibiting shifting). Blocks 710 and 720 respectively comprise the receiving of a signal indicative of a speed parameter and a signal indicative of an accelerator input. The speed parameter may be any speed parameter suitable for enabling a determination of a gear ratio in which to place the automatic transmission 12.

For example, the speed parameter may be a speed parameter of the vehicle 1, such as its longitudinal speed (a longitudinal direction being defined by an axis between the front and rear of the vehicle 1). Alternatively, the speed parameter may be a speed parameter of a powertrain component, such as a rotational speed of one or more of the wheels 34, or of a transmission output shaft 20, or of a transmission input shaft 18 (which may be measured from a rotational speed of a turbine of the torque converter 14), or of the engine 24 and/or electric machine 26. In some examples, the speed parameter may be a ratio between foregoing parameters, particularly between those pertaining to speeds on either side of the gear set 16, such as a ratio between the vehicle's longitudinal speed and the engine/electric machine speed or a ratio between the wheel speed and the transmission input shaft speed.

In some examples the speed of the transmission output shaft 20 may be used because it may be measured within the automatic transmission system 10 and accordingly network latency and communication issues do not affect the signal which is indicative of it. The accelerator input may be dependent on for example, accelerator pedal depression (APD) or autonomous driving torque demand from an automated driving system (ADS) or an advanced driver-assistance system (ADAS). The accelerator input may be indicative of a torque requested or to be requested of the propulsion system 22.

Block 730 comprises the determining of a target gear ratio based on the speed parameter and the accelerator input. The target gear ratio may be determined with reference to an active shift map. Shift maps define a plurality of regions of a parameter space which is spanned by the speed parameter and the accelerator input. Each of these regions is associated with a different gear ratio (i_{g})ⱼ. The target gear ratio can be determined as a gear ratio associated with the region in which the point described by the values of the speed parameter and accelerator input lies. A gear ratio proposed by a shift map may however be further subjected to restrictions on gear availability and so the target gear ratio may instead be based on the output from a shift map.

A plurality of shift maps may be stored in the memory 108 of the control system 100. The shift map which will be active can be selected based on internal and external factors such as, for example: road load (a reflection of driving resistance calculated from weight, slope, or the like), driving style of the driver, the operating mode of the propulsion system 22. In some examples, multiple stored shift maps may be selected and interpolation between these performed to generate the active shift map. Additionally or alternatively, shift thresholds defined by the selected or interpolated shift map may be modified to compensate for, for example, engine speed limitation, altitude and temperature, reduced powertrain capability.

During a transition from the electric mode to the parallel hybrid mode, the active shift map may be changed from one suitable for electric mode (which will tend to maintain the electric machine 26 at higher speeds) to one suitable for parallel hybrid mode (which will tend to maintain the electric machine 26 at lower speeds). As a result, assuming otherwise unchanged driving conditions (e.g., vehicle speed), the change in the active shift map will promote a change in the target gear ratio to a lower gear ratio, sometimes of multiple steps.

Block 740 comprises determining if the target gear ratio is identified as permitted according to any previous examples. For example, an indication of the one or more gear ratios (i_{g})ⱼ in which the available wheel torque (T_{W})ⱼ exceeds a predefined fraction α of the obtained wheel torque T_{W_initial} may be provided as an input parameter to block 740. In some, but not necessarily all, examples this may involve providing the permitted gear ratios G′ (output from the method 500) as an input to block 740.

If the target gear ratio is identified as permitted (‘Y’ path from block 740), the method 700 advances to block 750. Block 750 comprises outputting a signal comprising instructions to cause initiation of a shift to the target gear ratio.

If the target gear ratio is not identified as permitted (‘N’ path from block 740), the method 700 advances to block 760. Block 760 comprises inhibiting output of a signal comprising instructions to cause initiation of a shift to the target gear ratio. Optionally, the method 700 can include block 770. Block 770 comprises adjusting the target gear ratio so that it is set equal to the next gear ratio between the target gear ratio and the current gear ratio i_{g_current}. In other words, the target gear ratio is incremented one step back towards the current gear ratio i_{g_current}. The adjusted target gear ratio is then passed to block 740. This repeats until an adjusted target gear ratio is determined which is permitted. Accordingly, in examples where the method 700 includes block 770, it results in the output of a signal comprising instructions to cause initiation of a shift to a closest gear ratio to the original target gear ratio which is permitted.

As used herein, the term ‘obtain/obtaining’ (and grammatical variants thereof) can include, not least: calculating, computing, processing, deriving, measuring, investigating, identifying, looking up (for example, looking up in a table, a database or another data structure), ascertaining and the like. Also, ‘obtain/obtaining’ can include receiving (for example, receiving information), accessing (for example, accessing data in a memory), determining and the like. Also, ‘obtain/obtaining’ can include resolving, selecting, choosing, establishing, and the like.

It will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc. It will be appreciated that various changes and modifications can be made to the present invention without departing from the scope of the present application.

The blocks illustrated in the FIGS. 7 to 13 may represent steps in a method and/or sections of code in the computer program 110. The illustration of a particular order to the blocks does not necessarily imply that there is a required or preferred order for the blocks and the order and arrangement of the block may be varied. Furthermore, it may be possible for some steps to be omitted.

For purposes of this disclosure, it is to be understood that the controller(s) described herein can each comprise a control unit or computational device having one or more electronic processors, the one or more processors collectively configured to perform the control system functionality set out in the control system claims. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not.

1. A control system for an automatic transmission of a vehicle, the control system comprising one or more controllers, the control system configured to:
receive an input signal indicative of a status of a propulsion system of the vehicle;
obtain a current wheel torque in dependence on the propulsion system being in transition from an electric mode to a parallel hybrid mode;
determine an available wheel torque in one or more gear ratios which are selectable within the automatic transmission;
determine whether the available wheel torque in the one or more gear ratios exceeds a predefined fraction of the obtained wheel torque;
permit shifting to any of the one or more gear ratios in which the available wheel torque exceeds the predefined fraction of the obtained wheel torque; and
inhibit shifting to any of the one or more gear ratios in which the available wheel torque is less than or equal to the predefined fraction of the obtained wheel torque.

2. The control system of claim 1, wherein the control system is configured to:
receive a signal indicative of a current torque at an input shaft to the automatic transmission;
determine the available wheel torque in the one or more gear ratios by multiplying respective ones of the one or more gear ratios by a final drive ratio and by either: the current torque at the input shaft to the automatic transmission or a projected torque at the input shaft to the automatic transmission.

3. The control system of claim 2, wherein the control system is configured to:
receive a signal indicative of a power limit applied to an electric machine; and
receive a signal indicative of a current speed of the electric machine,
wherein the projected torque at the input shaft to the automatic transmission is given by a minimum between:
the power limit applied to the electric machine, multiplied by a gear ratio between the electric machine and the input shaft, divided by an expected speed of the electric machine at a current vehicle speed for respective ones of the one or more gear ratios; and
a target torque for the input shaft based on an accelerator input.

4. The control system of claim 3, wherein the expected speed of the electric machine at the current vehicle speed for respective ones of the one or more gear ratios is given by:
the current speed of the electric machine, multiplied by respective ones of the one or more gear ratios, divided by a current gear ratio.

5. The control system of claim 2, wherein the control system is configured to:
determine if the current torque at the input shaft to the automatic transmission is within a tuneable offset of: the power limit applied to the electric machine, multiplied by a gear ratio between the electric machine and the input shaft to the automatic transmission, divided by the current speed of the electric machine; and
if so, the available wheel torque in the one or more gear ratios is determined by multiplying respective ones of the one or more gear ratios by the projected torque at the input shaft to the automatic transmission and by the final drive ratio, and
if not, the available wheel torque in the one or more gear ratios is determined by multiplying respective ones of the one or more gear ratios by the current torque at the input shaft to the automatic transmission and by the final drive ratio.

6. The control system of claim 1, wherein the control system is configured to:
continue determining an available wheel torque in one or more gear ratios and continue inhibiting shifting to any of the one or more gear ratios in which the available wheel torque does not exceed the predefined fraction of the obtained wheel torque while the propulsion system is in transition from the electric mode to the parallel hybrid mode and for a predefined period following completion of the transition into the parallel hybrid mode.

7. The control system of claim 1, wherein the control system is configured to:
determine whether the available wheel torque in the one or more gear ratios exceeds at least one from the following: a predefined fraction of a wheel torque demand; a predefined fraction of an available wheel torque in a current gear ratio,
wherein permitted shifting is limited to those of the one or more gear ratios in which the available wheel torque exceeds at least one from the following: the predefined fraction of the wheel torque demand; the predefined fraction of the available wheel torque in a current gear ratio.

8. The control system of claim 7, wherein the wheel torque demand is given by:
a target torque for an input shaft to the automatic transmission based on an accelerator input, multiplied by the current gear ratio, multiplied by a final drive ratio.

9. The control system of claim 7, wherein the available wheel torque in the current gear ratio is given by:
a gear ratio between the electric machine and the input shaft to the automatic transmission, multiplied by the current gear ratio, multiplied by a final drive ratio, multiplied by a minimum between:
a maximum available electric machine torque indicated by a received input signal;
a power limit applied to the electric machine, divided by the current speed of the electric machine.

10. The control system of claim 7, wherein the control system is configured to:
determine if the wheel torque demand is increasing by at least a threshold amount or at at least a threshold rate,
wherein, if the wheel torque demand is increasing by at least the threshold amount or at at least the threshold rate, permitted shifting is limited those of the one or more gear ratios in which the available wheel torque exceeds both the predefined fraction of the wheel torque demand and the predefined fraction of the available wheel torque in the current gear ratio.

11. The control system of claim 10, wherein, if the wheel torque demand is not increasing by at least the threshold amount or at at least the threshold rate, permitted shifting is limited those of the one or more gear ratios in which the available wheel torque exceeds a predefined fraction of a minimum between:
the wheel torque demand; and
the available wheel torque in the current gear ratio.

12. An automatic transmission system comprising the control system of claim 1 and an automatic transmission.

13. A vehicle comprising the automatic transmission system of claim 12.

14. A method of controlling an automatic transmission of a vehicle, the method comprising:
receiving an input signal indicative of a status of a propulsion system of the vehicle;
obtaining a current wheel torque in dependence on the propulsion system being in transition from an electric mode to a parallel hybrid mode;
determining an available wheel torque in one or more gear ratios which are selectable within the automatic transmission;
determining whether the available wheel torque in the one or more gear ratios exceeds a predefined fraction of the obtained wheel torque;
permitting shifting to any of the one or more gear ratios in which the available wheel torque exceeds the predefined fraction of the obtained wheel torque; and
inhibiting shifting to any of the one or more gear ratios in which the available wheel torque is less than or equal to the predefined fraction of the obtained wheel torque.

15. Computer readable instructions which, when executed by a computer, are arranged to perform a method according to claim 14.
